(19) United States
(12) Patent Application Publication
(10) Pub. No.: US 2003/0093369 A1
(43) Pub. Date: May 15, 2003

(54) Transaction intermediate service providing method and system

(75) Inventors: Makoto Ijichi, Yokohama (JP); Toshiyuki Yamaguchi, Yokohama (JP); Seiji Futatsugi, Kawasaki (JP); Takeshi Yokota, Hitachi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/159,145

(22) Filed: May 31, 2002

(30) Foreign Application Priority Data
Nov. 12, 2001 (JP) 2001-346328

(51) Int. Cl. G06F 17/60

(52) U.S. Cl. 705/39

(57) ABSTRACT

A transaction intermediate service providing technique for intermediating a transaction between transaction requesting parties through a financial institution based on credit information. An intermediate server receives condition information including the credit information and desired level information from a transaction requesting party for registration in a database. The server matches article attributes and essential condition information between transaction requesting parties based on the received information with reference to the database. Then, the server determines the transaction establishment possibility by comparing a priority or a weighting factor assigned to the priority in the desired level information between the transaction requesting parties to find a matching degree, and determining based on the matching degree the possibility that a transaction is established between both parties. The server provides the transaction requesting parties with a candidate transaction partner list from the result of the establishment possibility determination for enumerating candidate transaction partners.

### BACKGROUND OF THE INVENTION

The present invention relates to a method and system interposed between a candidate purchaser and a candidate offerer, which make a transaction on articles and/or services with each other, for providing an intermediate service intermediated by a credit organization such as a financial institution which holds credit information on both parties.

With the proliferation of the Internet, a variety of cyber shops and platforms for inter-business transactions have been operated on the Internet, now allowing electronic commerce to become widespread irrespective of individuals or companies. These electronic commerce on the Internet involve a candidate purchaser which wishes to purchase an article, a service or the like, and a candidate offerer which wishes to offer such a desired article or the like. However, a large number of such candidate purchasers and candidate offerers (a majority of which are cyber shops) flood over networks through a wide variety of needs, so that even if “sites” such as a cyber mall, by way of example, are provided for them, it is not easy to precisely understand the needs on both parties and connect them to establish a transaction.

To solve the foregoing situation, a method has been proposed for intermediating between a candidate purchaser and a candidate offerer, wherein a candidate offerer which appears to respond to requirements of each candidate purchaser is selected from a plurality of candidate offerers depending on conditions such as an article category, a price and the like. Such an approach is mainly intended to provide for efficient transactions through an intermediator between parties concerned of an electronic commerce. See, for example, U.S. Pat. No. 6,134,326 issued to Mi ca li.

### SUMMARY OF THE INVENTION

However, the technical idea underlying the conventional approach still remains similar to techniques for operating a cyber mall and letting mall members know registered cyber shops collected in the cyber mall through a search service. Assuming, for example, that an intermediated electronic commerce is made on an inter-business basis, a contract is usually concluded after confirming the creditability and financial status of transaction partners. However, in a transaction based on the cyber mall, a determination on intermediation must be based only on company information spontaneously declared by transaction partners themselves, and even if such credit information is verified, the cost and labor amount to an unnegligible level due to a credit inquiry which should be separately made.

In addition, business chances possibly provided through the cyber mall are limited only to those which know the existence of the cyber mall, B-to-B sites and the like and have been registered therein, and no means has been provided for conveniently verifying a transaction quality, a financial condition, and the like of even limited transaction partners. Furthermore, the conventional approach fails to find out a partner by specifying not only simple transaction conditions such as the name, quantity and the like of a desired article but also detailed conditions including a financial condition, a financial situation and the like.

Stated another way, the conventional approach encounters difficulties in conveniently and rapidly retrieving optimal transaction partners for both of a party which purchases an article or a service and a party which offers it to reliably verify details of a transaction. Of course, any party can be in danger of making a transaction with a partner without knowing that this partner is not optimal in view of transaction conditions, transaction quality, financial condition, and the like.

The present invention has been made in view of the problems left unsolved in the prior art, and it is an object of the invention to provide a transaction intermediate service providing method and system which are capable of precisely and rapidly intermediating a highly reliable transaction partner which meets detailed transaction conditions, and additionally proposing a financial instrument commensurate with a transaction situation.

To achieve the above object, a transaction intermediate service providing method according to one aspect of the present invention provides an intermediate service for a candidate purchaser and a candidate offerer which make a transaction on an article and/or a service with each other, wherein a transaction is intermediated by a credit organization such as a financial institution which holds credit information on both the candidate purchaser and the candidate offerer. The method includes an information acquisition procedure for accepting at a server, condition information including attribute condition information on an article desired for a transaction, transaction condition information including a desired price and parties with which the transaction is denied, and credit condition information including a financial condition desired for a transaction partner, and desired level information including information on essentiality or priority, or a weighting factor assigned to the priority for each of conditions included in the condition information, from a purchaser terminal installed at the candidate purchaser and an offerer terminal installed at the candidate offerer, and registering the accepted information in a database, an analysis and processing procedure for performing matching processing for the article attribute condition information and essential condition information between the candidate purchaser and the candidate offerer based on the acquired condition information and desired level information, and performing establishment possibility determination processing by comparing the candidate purchaser with the candidate offerer for the priority or the weighting factor assigned to the priority in the desired level information to find a matching degree, and determining the possibility that a transaction is established between the candidate purchaser and the candidate offerer based on the matching degree, and a candidate list transmission procedure for collecting candidate purchasers or candidate offerers which wish for the same article in the transaction and match in the essential condition information, found from the matching processing, to create a candidate transaction partner list, associated with the result of the establishment possibility determination processing, and transmitting the candidate transaction partner list to purchaser terminals and offerer terminals of candidate purchasers and candidate offerers which are listed on the candidate transaction partner list.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating a transaction intermediate service providing system according to one embodiment of the present invention;

FIG. 2 is an explanatory diagram showing an exemplary data structure in a candidate purchaser database;

FIG. 3 is an explanatory diagram showing an exemplary data structure in a candidate offerer database;

FIG. 4 is an explanatory diagram showing an exemplary data structure related to a candidate purchaser registered in a database internal to a financial institution;

FIG. 5 is an explanatory diagram showing an exemplary data structure related to a candidate offerer registered in the database internal to the financial institution;

FIG. 6 is an explanatory diagram showing an exemplary data structure in a transaction result database;

FIG. 7 is a flow chart illustrating an actual procedure of a transaction intermediate service providing method according to the embodiment of the present invention;

FIG. 8 is an explanatory diagram illustrating an exemplary information input screen provided on a terminal of a candidate purchaser;

FIG. 9 is an explanatory diagram illustrating an exemplary information input screen provided on a terminal of a candidate offerer;

FIG. 10 is an explanatory diagram illustrating an exemplary information output screen provided on the terminal of the candidate purchaser;

FIG. 11 is an explanatory diagram illustrating an exemplary information output screen provided on the terminal of the candidate offerer;

FIG. 12 is an explanatory diagram illustrating an exemplary purchase condition output screen provided on the terminal of the candidate purchaser;

FIG. 13 is an explanatory diagram illustrating an exemplary offering condition output screen provided on the terminal of the candidate offerer;

FIG. 14 is an explanatory diagram illustrating an exemplary transaction contract notice screen when a transaction is established; and

FIG. 15 is an explanatory diagram illustrating an exemplary transaction contract notice screen when a transaction fails to conclude into establishment.

### DETAILED DESCRIPTION OF THE EMBODIMENTS

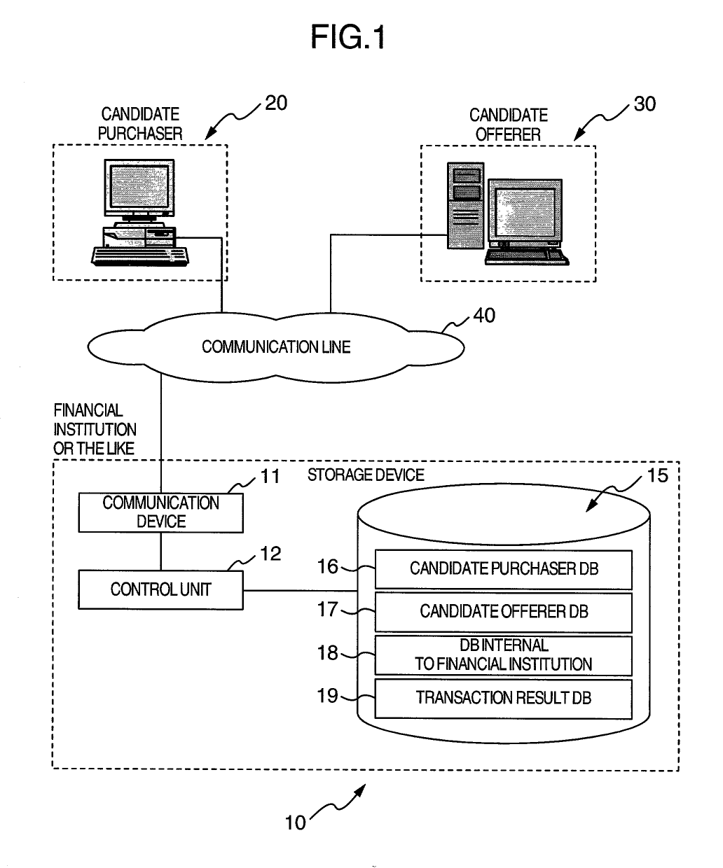

In the following, one embodiment of the present invention will be described in detail with reference to the accompanying drawings. FIG. 1 is a block diagram generally illustrating a transaction intermediate service providing system 10. As a background of this embodiment, assume that the present invention is applied to an electronic commerce on a site operated by a financial institution for inter-business transactions, wherein the system of the present invention intermediates the electronic commerce performed on the site between clients of the financial institution. It should be of course understood that the applicable scope of present invention is not limited to the following embodiment, but can be applied to any case in which a credit organization which holds credit information intermediates an electronic commerce using the credit information.

Assume herein that the system 10 installed in the financial institution acts as a server. The server 10 comprises a communication device 11 for providing data communications with a purchaser terminal 20 and an offerer terminal 30 through a communication line 40 such as the Internet connected thereto. The server 10 also comprises a control unit 12 for controlling the communication device 11, a storage device, and associated devices such as an input/output interface and the like. For implementing a transaction intermediate serve providing method of the present invention, it is necessary to previously acquire and manage a variety of information on candidate purchasers and candidate offerers. For this purpose, the server 10 has a database set 15 which includes a candidate purchaser database 16; a candidate offerer database 17; a database 18 internal to the financial institution; and a transaction result database 19.

On the other hand, the candidate purchaser may be a company or firm which wishes to purchase articles utilizing an inter-business transaction site, for example, provided by the financial institution on a network, and comprises a purchaser terminal 20 which can be connected to a network for utilizing the site. Similarly, the candidate offerer may be a company which wishes to sell articles on the inter-business transaction site, and comprises an offerer terminal 30 which can be connected to a network for utilizing the site. The candidate purchaser and candidate offerer are in a fixed relationship if the former only intends to purchase articles and the latter only intends to sell articles, but they may be interchangeable as appropriate without causing any problem.

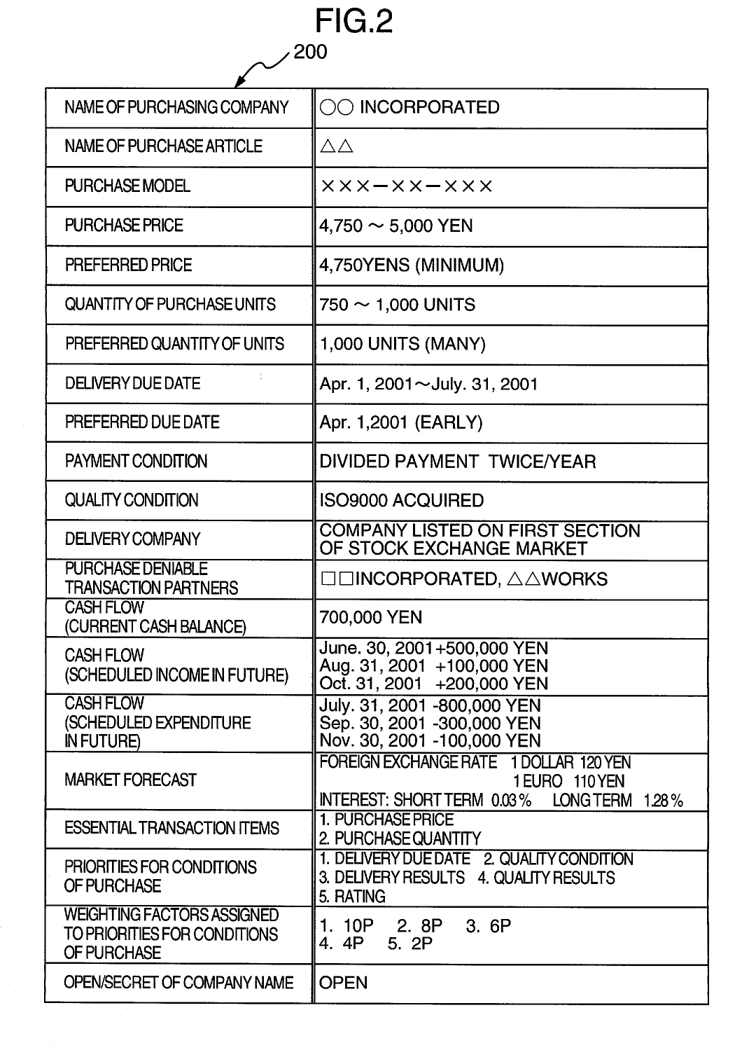

Now, the data structures of the respective databases in the database set 15 provided in the server 10 will be explained with reference to FIGS. 2 to 6. For implementing the transaction intermediate service providing method of the present invention, the server 10 first receives, from the candidate purchaser and candidate offerer, condition information including attribute condition information about a desired article in a transaction, transaction condition information such as a desired price, parties with which the transaction is denied, and the like, and credit condition information such as a financial condition desired for a transaction partner, and request level information including information on the essentiality or priority or a weighting factor for the priority for each of conditions included in the condition information, and registers the information in the database set 15.

The candidate purchaser database 16 registers candidate purchaser information, for each candidate purchaser, which may be acquired from the candidate purchaser or previously held by the financial institution. As shown in an exemplary data structure 200 in FIG. 2, the candidate purchaser database 16 registers, beginning with the name of a desired purchaser, information items labeled article attribution information such as a product name, a model number or the like of a desired article; a desired purchase price (which can be in a range of, for example, 4,750 to 5,000 yen); a preferred price (for example, the minimum price of 4,750 yen); a purchased quantity (which can be in a range of, for example, 750 to 1,000); a preferred quantity (for example, 1,000 which is the largest quantity); a due date (for example, from Apr. 1, 2001-Jul. 31, 2001); a preferred delivery date (for example, Apr. 1, 2001 which is the earliest delivery date); a payment condition (for example, divided payment, twice a year); quality conditions for a product and a factory which manufactures the product (for example, acquisition of ISO9000 required); social creditability of a supplier as a candidate offerer (for example, whether or not the stock is listed); transaction deniable companies (transaction partners with which no purchase can be made); cash flows of the candidate purchaser (the balance of an account held by the candidate purchaser in the financial institution, scheduled income and expenditure in the future); a market forecast (movements of the foreign exchange rate, long-term and short-term interests, and the like); essential transaction items (for example, a purchaser price and purchase quantity); priorities desired for a purchase (for example, a delivery date is given the highest priority; quality conditions, the second; delivery results, the third; quality results, the fourth; financial rating, the fifth); weighting factors for the priorities desired for a purchase (for example, the highest priority is given 10 points; the second highest, 8 points; the third, 6 points; the fourth, 4 points; the fifth, 2 points); and secret/open of the company name.

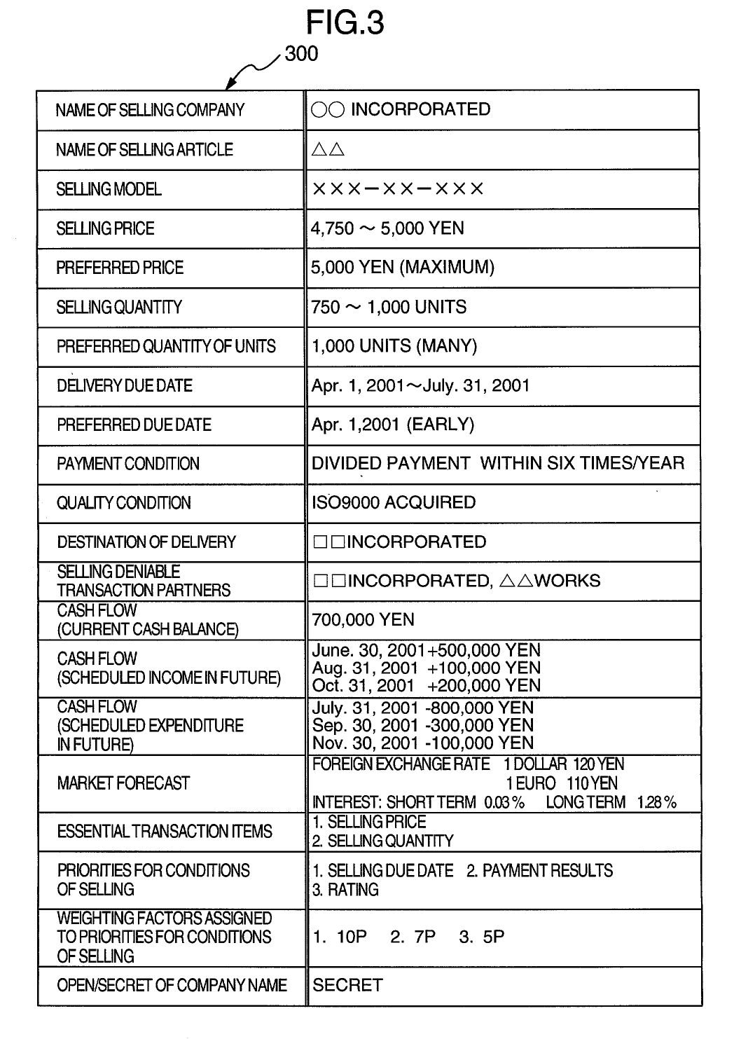

The candidate offerer database 17 in turn registers candidate offerer information, for each candidate offerer, which may be acquired from the candidate offerer or previously held by the financial institution. FIG. 3 shows an exemplary data structure 300 of the database 17. Basically, data registered in the database 17 are similar to those in the candidate purchaser database 16. A difference lies only in that the position changes from purchase to provision (sale).

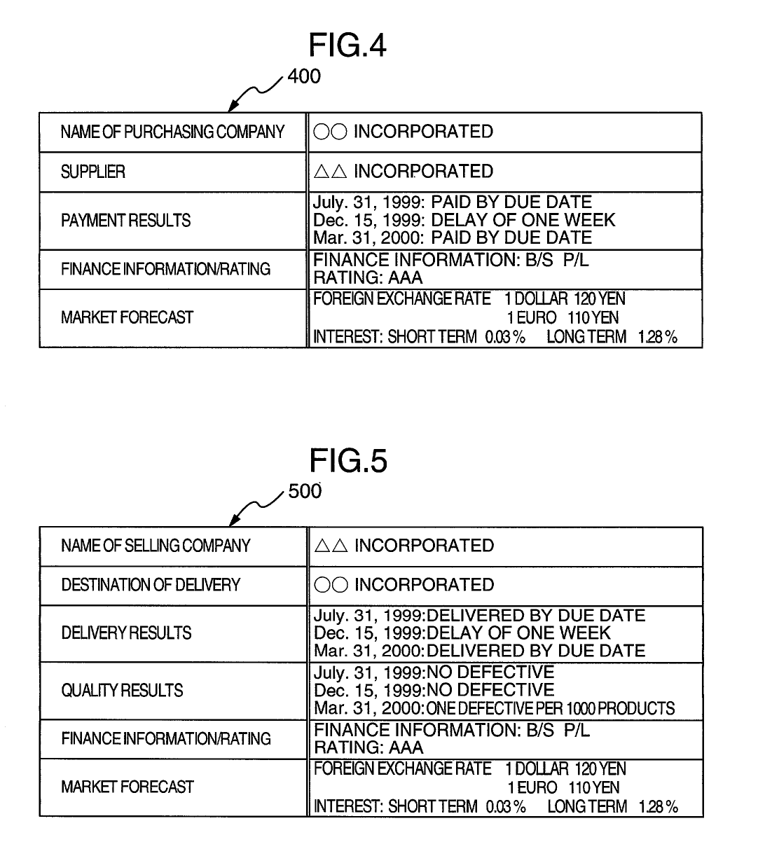

The database 18 internal to the financial institution in turn registers credit information, finance information and the like accumulated by the financial institution on each of candidate purchasers and candidate offerers. FIG. 4 shows an exemplary data structure 400 related to a candidate purchaser, and FIG. 5 shows an exemplary data structure 500 related to a candidate offerer. Keyed by a company name, the database 18 stores payment results, delivery results (within the due date, one week of delay, and the like), financial information (for example, balance sheet (B/S), profit and loss (P/L)), rating (for example, AAA and the like determined by a rating organization or the like), market forecast information, and the like. For a candidate offerer, the database 18 additionally stores information on the quality results related to articles dealt with thereby. This can be a criterion for a fraction defective of articles dealt with by the candidate offerer.

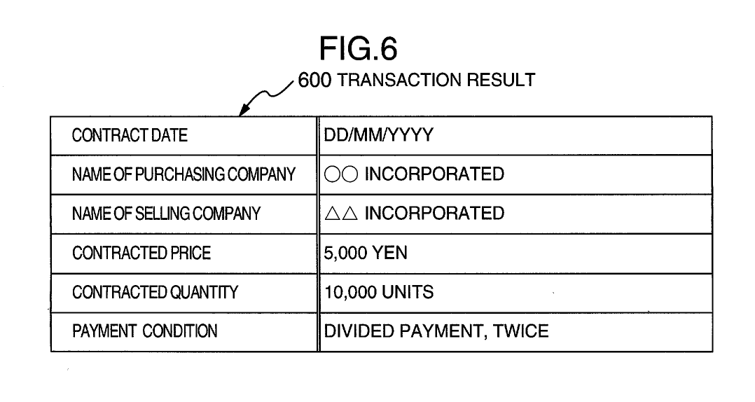

When a transaction is established in the transaction intermediate service providing method of the present invention, the result is stored in the transaction result database 19. FIG. 6 shows an exemplary data structure 600 of the transaction result database 19. Here, the database 19 enumerates in pair a purchasing company (candidate purchaser) and a selling (sales) company (candidate offerer) which concluded a transaction, which are related to information such as a contracted price, a contracted quantity, a sales (selling) contract, and the like. Of course, these information items are preferably reflected to and synchronized with the aforementioned candidate purchaser database 16, candidate offerer database 17, and database 18 internal to the financial institution. For example, when a transaction contract is established between a company A and a company B, accesses to these databases may be invalidated from the outside.

Each of the databases 16, 17, 18, 19 may function as an independent individual database installed in a different storage device and interconnected through a network, may be combined as appropriate, or may be integrated in a single storage device. The purchaser terminal 20 and offerer terminal 30 may be any device which comprises a computer chip connectable to a network, for example, a portable telephone, PDA, game machine, facsimile machine, digital TV, and the like which can be connected to a network, as well as a general personal computer.

In addition, the network which interconnects the server 10, purchaser terminal 20, offerer terminal 30 and the like may be implemented by any of a variety of networks such as an ATM line, a personal-computer communication line, a LAN, a wireless network and the like, as well as the Internet.

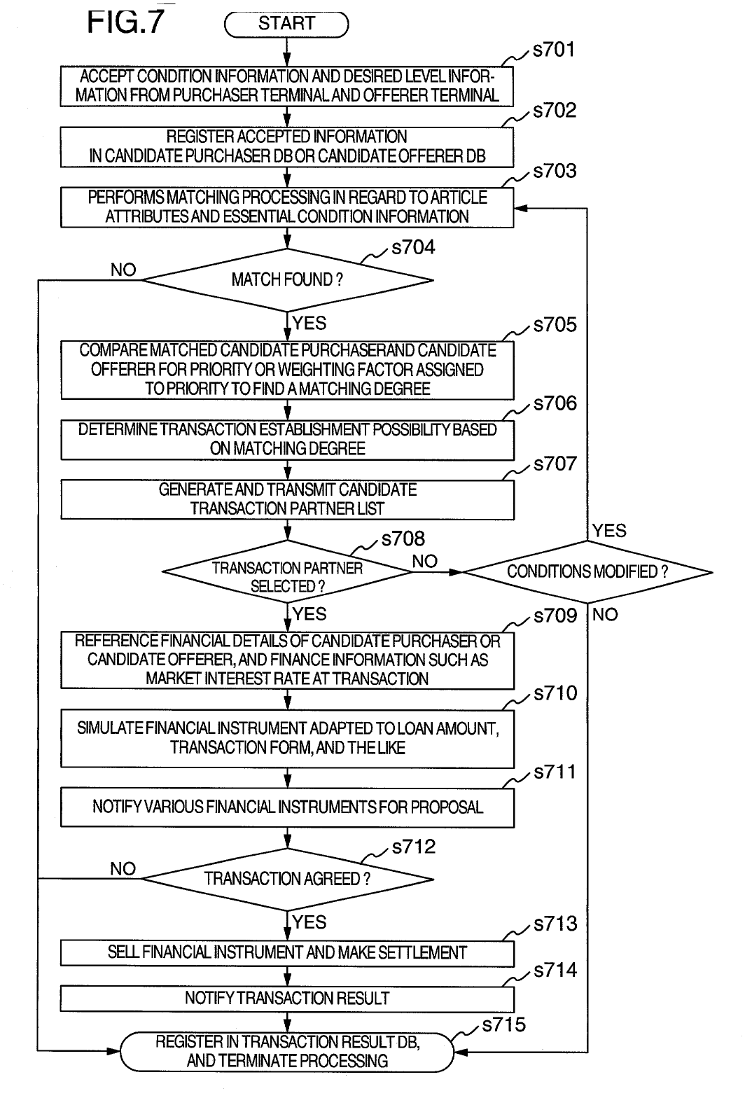

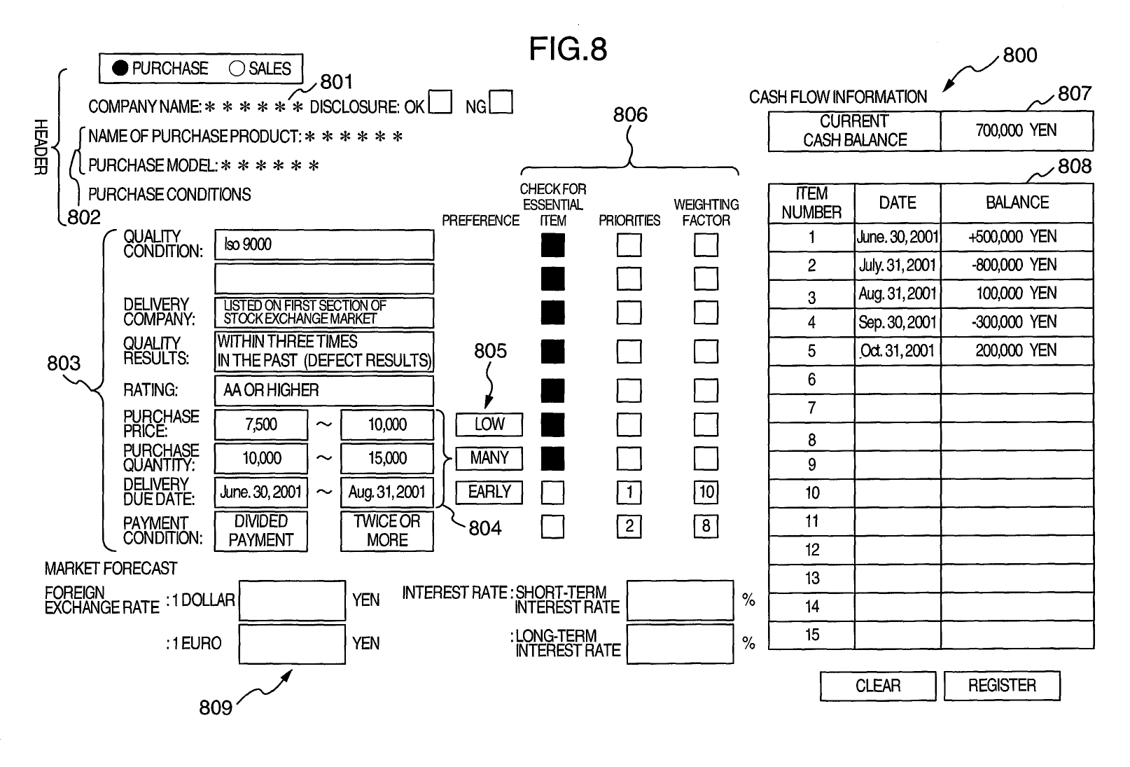

FIG. 7 illustrates in a flow chart form an actual procedure involved in the transaction intermediate service providing method in this embodiment. The following description will be made on the actual procedure of the transaction intermediate service providing method in this embodiment. The financial institution which provides a transaction intermediate service conforming to the present invention manages and operates the server 10, and accepts accesses from the purchaser terminal 20 and offerer terminal 30. Responsive to an access, the server 10 transmits a log-in screen of the transaction intermediate service. A candidate purchaser which wishes to purchase a certain article, for example, logs in on this log-in screen before jumping to an information input screen for inputting a wish for a purchase. Upon receipt of the log-in operation, the server 10 transmits an information input screen 800 illustrated in FIG. 8 back to the candidate purchaser.

On the screen 800, the candidate purchaser can enter information on the respective items which have been described in connection with exemplary data structure 200 in the candidate purchaser database 16. The screen 800 comprises a company name field 801 for entering a company name, which represents the candidate purchaser, with options to keep the company name secret or open the company name; an attribute condition information field 802 for entering attribute information such as the name, model number or the like of an article which the candidate purchaser wishes to purchase. The company name field 801 and attribute condition information field 802 constitute a header. The header is followed by a purchase condition field 803 for entering transaction condition information and credit condition information. Since input items in the data structure 200 are identical to those registered in the candidate purchaser database 16 and are of course linked to the candidate purchaser database 16, enumeration and description of the items are omitted.

A characteristic feature in the entry of conditions lies in that a condition extending over a predetermined range specified for each of a desired purchase price, quantity and due date is accepted in a range specifying field 804, and a preferred region within the predetermined range can be specified in a priority field 805. For example, in regard to the price, “low” may be specified within a range specified in the range specifying field 804 to indicate that a lower purchase price is considered as better. On the other hand, in regard to the purchase quantity, “many” is specified because a larger purchase quantity is more desired. Further, in regard to the delivery due date, “early” is specified to set forth that the article is desirably delivered as early as possible.

For the transaction condition information and credit condition information, the essentiality of each condition, priorities among conditions, and weighting factors therefor can be specified in a desired level information field 806. In FIG. 8, essential items in making a transaction set forth by the candidate purchaser includes that a transaction partner (candidate offerer) has achieved a quality condition such as ISO 9000 and JIS standard and is a major company, the stock of which is listed on the first section of the stock exchange market; the quality results show that the transaction partner has shipped defective products three times or less in the past; the transaction partner should be rated as AA or higher, for example, by a rating organization; and the purchase price and quantity.

In this way, the candidate purchaser is intermediated only to transaction partners which present satisfactory article quality conditions and transaction quality, and good financial status, a credible candidate offerer can be found out with certainty. Conventionally, each candidate purchaser or candidate offerer must separately request a credit bureau for credit information on a company, and independently investigate the acquired information. According to the present invention, since the intermediate service is provided by the financial institution which previously holds such credit information on candidate purchasers and candidate offerers in the database 18 internal to the financial institution as client credit information, it is possible to rapidly propose a transaction partner which satisfies credit conditions without burdening a candidate purchaser or a candidate offerer, which are service users, with any efforts and cost. As such, matching processing, i.e., establishment possibility determination processing related to the credit condition information involves comparing credit conditions desired by a candidate purchaser or a candidate offerer to its transaction partner with credit information held by the financial institution on highly reliable candidate purchasers or candidate offerers.

In regard to conditions other than those specified in the essential items, the priorities can be specified, for example, in such a manner that the delivery due date has a higher priority than the payment condition, and weighting factors can be assigned such as 10 points for the highest priority and 8 points for the second highest. In this way, it is possible to arbitrarily determine the importance among conditions having different priorities and finely narrow down transaction partners, not limited to simple ordering.

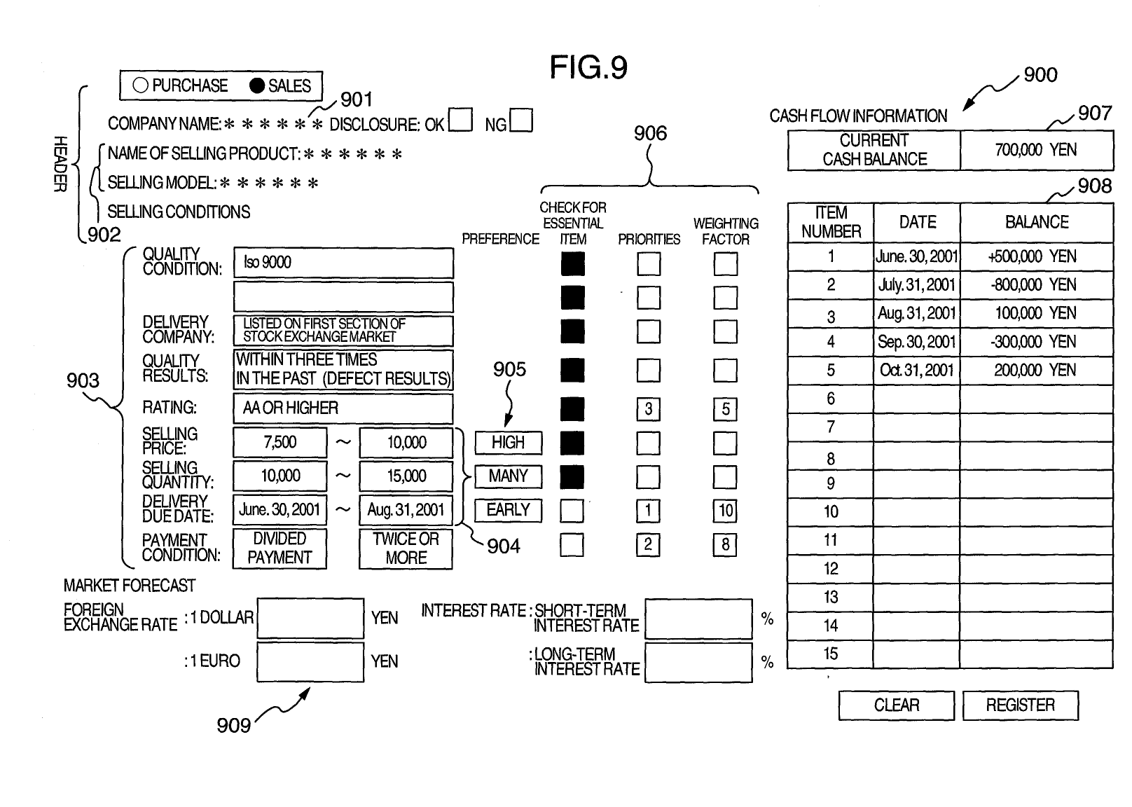

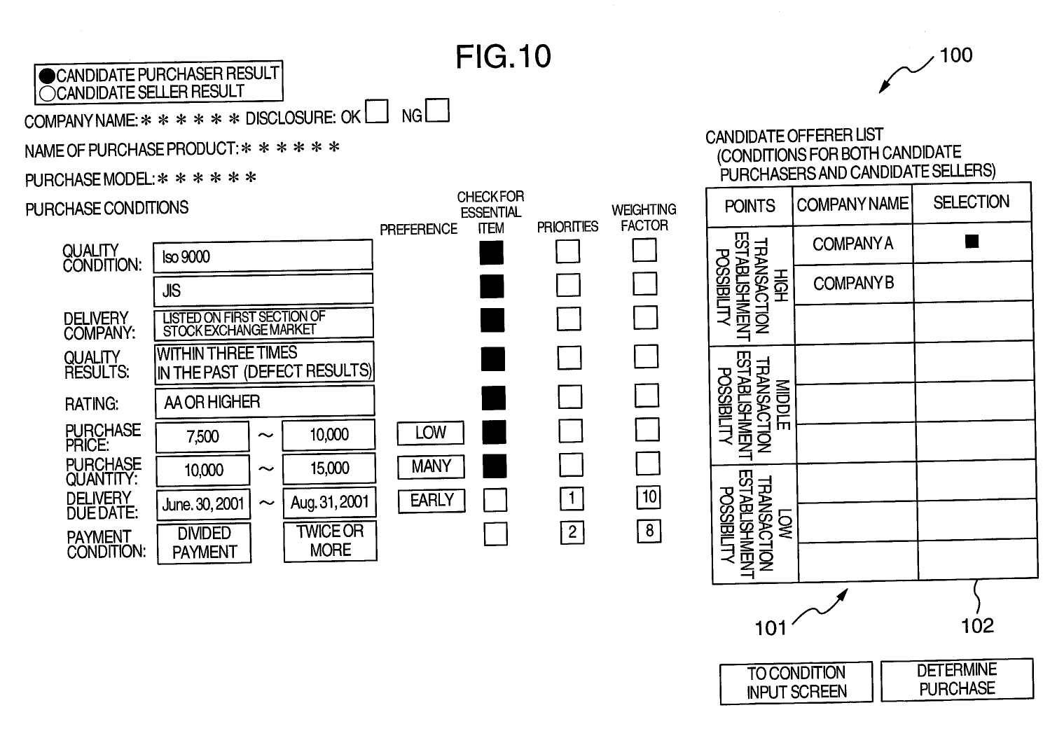

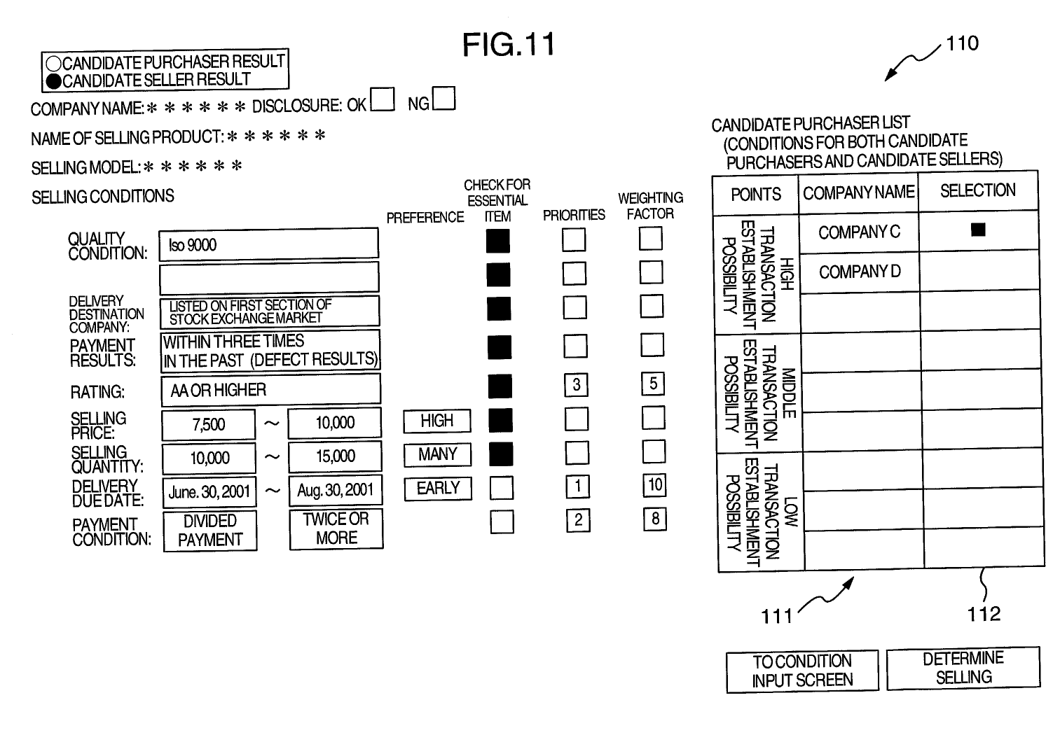

The information input screen 800 additionally presents fund information related to a candidate purchaser which accesses the server 10. The screen 800 has a balance field 807 for showing the cash balance in an account held by the candidate purchaser in the financial institution which provides the transaction intermediate service, and a balance change field 808 for showing a change in the balance in the account. From these fields, the candidate purchaser can apparently recognize a current fund situation thereof, and make a transaction. The screen 800 further shows a market forecast field 809 for showing the foreign exchange rate and interest information. On the other hand, an information input screen 900 is presented on the offerer terminal 30 of a candidate offerer for showing similar contents on the aforementioned information input screen 800, modified in favor of the candidate offerer. FIG. 9 shows the screen 900, wherein elements identical to those in FIG. 8 are designated reference numerals ending with the same numbers.

The information input screen 800 or information input screen 900, filled with the respective items mentioned above by the candidate purchaser or candidate offerer, is returned to the server 10 as a filled form. The server 10 receives the returned screen, and accepts the condition information including the attribute condition information, transaction condition information and credit condition information, and the desired level information 906 (s701). The accepted condition information and desired level information are registered in the candidate purchase database 16 or candidate offerer database 17 in accordance with the candidate purchaser or candidate offerer which has transmitted the information (s702).

When the candidate purchaser database 16 and candidate offerer database 17 are registered with data indicative of a wish for a transaction related to at least one pair of candidate purchaser and a candidate offerer, both parties can be subjected to matching processing related to a potential transaction. Thus, the server 10 performs the matching processing for the candidate purchaser and candidate offerer in regard to article attributes and essential condition information based on the acquired condition information and desired level information (s703). If a match is found (s704), this means that the databases have registered parties which present the same article in a transaction and match in the essential condition information. If no match is found, the processing is terminated.

The server 10 compares the matched candidate purchaser and candidate offerer for the priority or the weighting factor assigned to the priority in the desired level information to find a matching degree (s705), and determines the possibility that a transaction is established between both parties based on the matching degree (s706). Giving a specific example, assuming that the candidate purchaser gives the highest priority to the delivery due date and assigns 10 points to the weighting factor for the highest priority, while the candidate offerer also gives the highest priority to the delivery due data but assigns 6 points to the weighting factor for the highest priority, an averaged weighting factor of both parties is calculated as 8 points ((10+6)/2=8). Defining the average value as the matching degree, the server 10 can determine that a transaction between the parties concerned having 8 points is established with large possibility when the average value is in a range of 10 to 7; with middle possibility when in a range of 6 to 4; and with small possibility when in a range of 3 to 1. However, since the candidate offerer is not so obstinate about the delivery due date, though the average value is high, the server 10 may preferably employ a determination strategy in which the determination on the possibility is reduced by one rank to “middle.”

After determining the transaction establishment possibility, the server 10 collects candidate purchasers and candidate offerers which wish for the same article in the transaction and match in the essential condition information, associated with the result of determination on the transaction establishment possibility, to create a candidate transaction partner list (s707). Then, the server 10 transmits information output screens 100, 110 to the purchaser terminals 20 of the listed candidate purchasers and to the offerer terminals 30 of the listed candidate offerers, respectively. The screen 100 of course displays candidate transaction partner lists 101, 111 in addition to the condition information, desired level information, and the like derived from the candidate purchasers and candidate offerers, which are outputted in a similar manner to the aforementioned information input screens 800, 900. As an example, the candidate purchasers and candidate offerers are ranked as high, middle, low in regard to the transaction establishment possibility, and the names of companies, i.e., transaction partners associated therewith are enumerated in order from the highest possibility. If a party finds a partner with which a transaction is desired, the party checks in a selection box 102 or 112, and returns the information input screen to the server 10 for requesting transaction intermediation (s708). If there is no partner on the list with which a transaction is desired so that the candidate purchaser or candidate offerer wants to modify the conditions, the server 10 accepts the modifications to the conditions, and again performs the matching processing (s703).

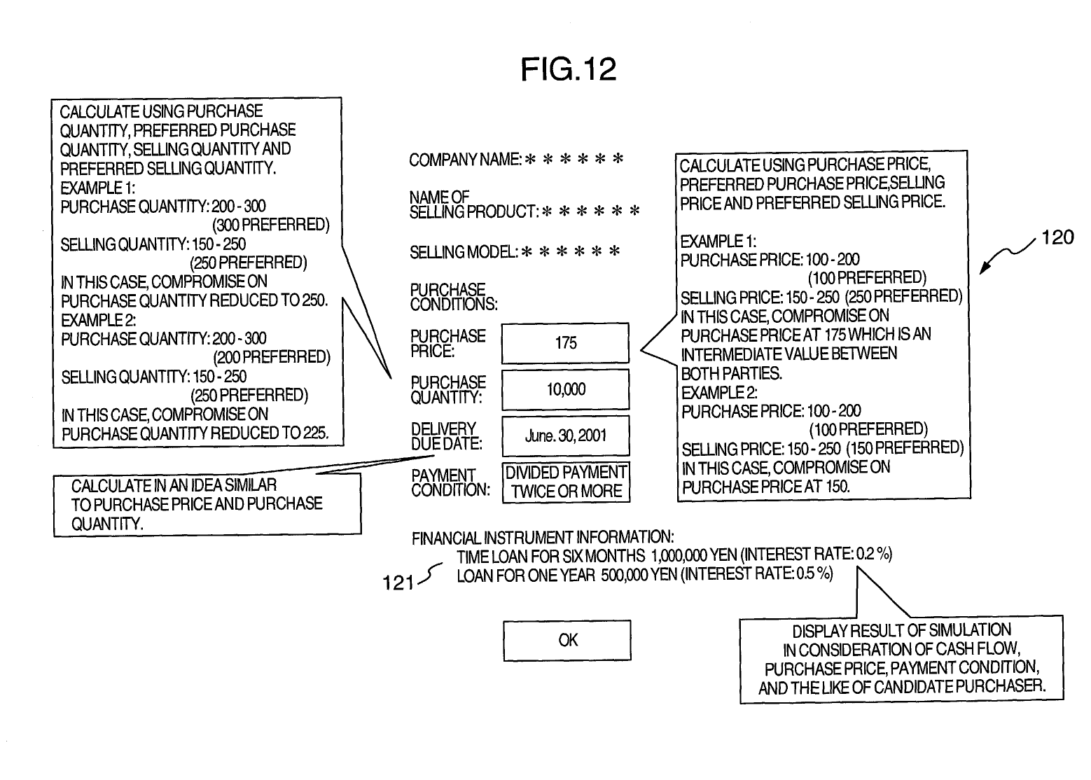

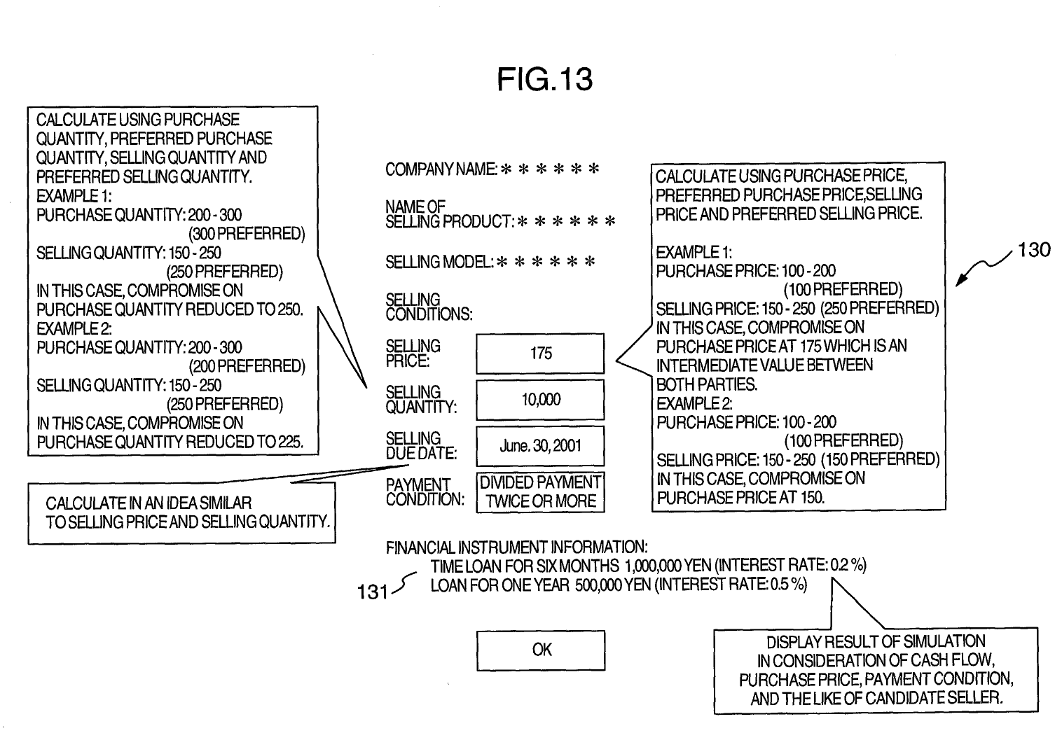

Upon receipt of the request for the transaction intermediation, the server 10 references the database set 15 for financial details of the candidate purchaser or candidate offerer, and a transaction form (s709), and accordingly extracts from the database set 15 financial instruments which match a financial demand which would arise in the transaction for simulation (s710). In accordance with the result of simulation, the server 10 notifies the associated purchaser terminal 20 or offerer terminal 30 of the financial instruments for proposal (s711). FIGS. 12 and 13 show a notice screen 120 sent to the purchaser terminal 20 and a notice terminal 130 sent to the offerer terminal 30, respectively. The candidate purchaser and candidate offerer which view these screens 120, 130 can acquire financial instrument information 121, 131 useful for a loan which may be needed in the transaction.

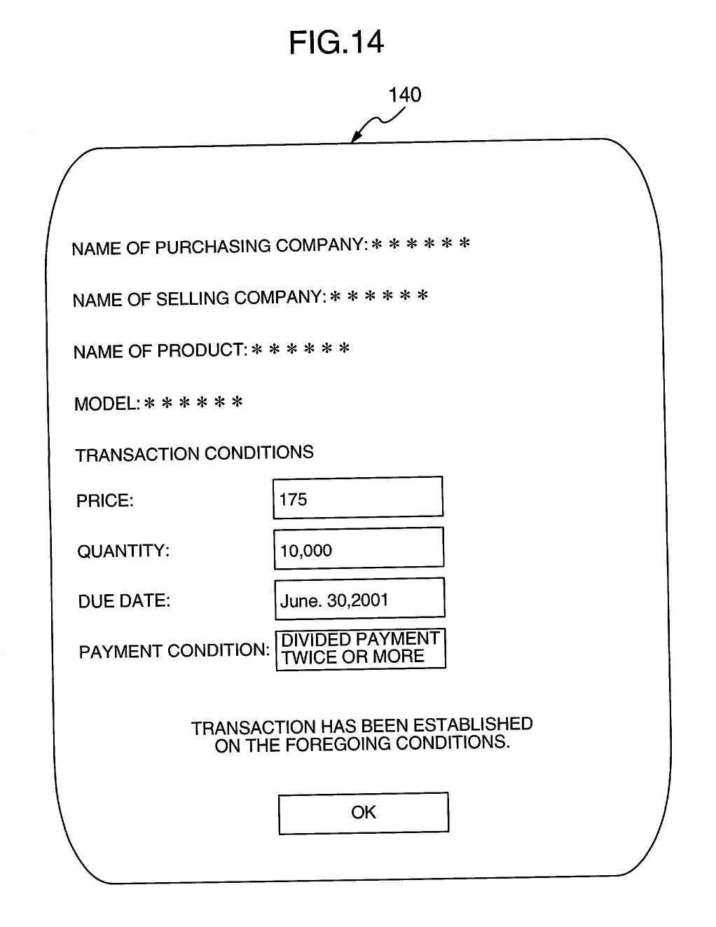

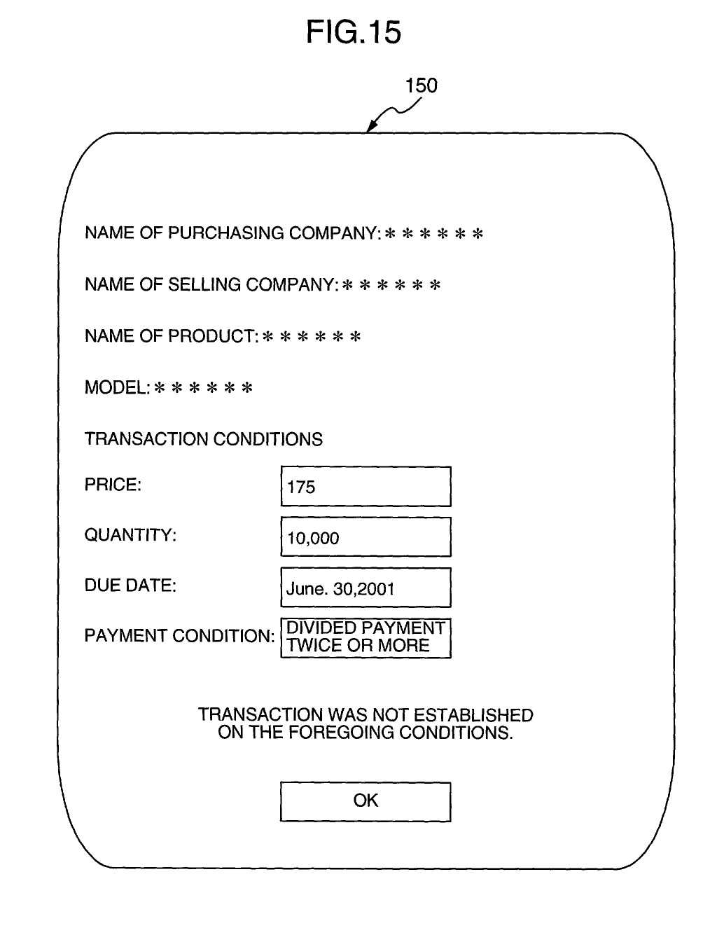

Assuming that through the foregoing procedure, the candidate purchaser or candidate offerer has found a transaction partner which meets desired conditions and recognized the financial instruments possibly needed in the transaction, and the candidate purchaser and candidate offerer have agreed the transaction through the intermediation of the server 10 (s712), a settlement is made in accordance with wishes of the candidate purchaser and candidate offerer by a movement of a settlement amount from the account of the candidate purchaser to the account of the candidate offerer. Also, associated with the settlement, the financial instrument previously proposed as mentioned above is sold to the candidate purchaser (s713). When a sequence of steps involved in the transaction is completed, the server 10 transmits a transaction establishment notice screen 140 as illustrated in FIG. 14 to the associated purchaser terminal 20 and offerer terminal 30 (s714). On the other hand, if the transaction is not established, the server 10 transmits a transaction failure notice screen 150 as illustrated in FIG. 15 to the associated purchaser terminal 20 and offerer terminal 30. Data included in the notice screens 140, 150 are registered in the transaction result database 19 (s715), followed by termination of the processing.

Another embodiment according to the present invention may be modified in the following manner for achieving the aforementioned object. In the execution of the matching processing related to the credit condition information or the establishment possibility determination processing, the transaction intermediate service providing method may include comparing credit conditions desired by a candidate purchaser or a candidate offerer to its transaction partner with credit information related to the candidate purchaser or candidate offerer held by the credit organization.

The transaction intermediate service providing method may also include extracting from the database set a financial instrument which matches a financial demand which may arise in the transaction in accordance with financial details of the candidate purchaser or candidate offerer, and a transaction form, and notifying the extracted financial instrument to a purchaser terminal of the associated candidate purchaser or to an offerer terminal of the associated candidate offerer.

The transaction intermediate service providing method may further include accepting a condition specified over a predetermined range, upon acceptance of the condition information from a purchaser terminal or an offerer terminal, and performing the matching processing by comparing the condition information with the predetermined range to see whether the condition information falls under the predetermined range.

Also, a transaction intermediate service providing system is interposed between a candidate purchaser and a candidate offerer which make a transaction on an article and/or a service with each other, for providing an intermediate service for the candidate purchaser and the candidate offerer, wherein a transaction is intermediated by a credit organization such as a financial institution which holds credit information on both of the candidate purchaser and the candidate offerer. The system is composed of an information acquisition device for accepting from a purchaser terminal installed at the candidate purchaser and an offerer terminal installed at the candidate offerer, condition information including attribute condition information on an article desired for a transaction, transaction condition information including a desired price and the like, and credit condition information including a financial condition desired for a transaction partner, and desired level information including information on essentiality or priority, or a weighting factor assigned to the priority for each of conditions included in the condition information, and registering the information in a database, an analysis and processing device for performing matching processing for the article attribute condition information and essential condition information between the candidate purchaser and the candidate offerer based on the acquired condition information and desired level information, and performing establishment possibility determination processing by comparing the candidate purchaser with the candidate offerer for the priority or the weighting factor assigned to the priority in the desired level information to find a matching degree, and determining the possibility that a transaction is established between both parties based on the matching degree, and a candidate list transmitting device for collecting candidate purchasers or candidate offerers which wish for the same article in the transaction and match in the essential condition information, found from the matching processing, to create a candidate transaction partner list, associated with the result of the establishment possibility determination processing, and transmitting the candidate transaction partner list to purchaser terminals and offerer terminals of candidate purchasers and candidate offerers which are listed on the candidate transaction partner list.

Further, a transaction intermediate service providing program provides an intermediate service for a candidate purchaser and a candidate offerer which make a transaction on an article and/or a service with each other, wherein a transaction is intermediated by a credit organization which holds credit information on both of the candidate purchaser and the candidate offerer. The program is composed of an information acquisition procedure for accepting from a purchaser terminal installed at the candidate purchaser and an offerer terminal installed at the candidate offerer, condition information including attribute condition information on an article desired for a transaction, transaction condition information including a desired price and parties with which the transaction is denied, and credit condition information including a financial condition desired for a transaction partner, and desired level information including information on essentiality or priority, or a weighting factor assigned to the priority for each of conditions included in the condition information, and registering the information in a database, an analysis and processing procedure for performing matching processing for the article attribute condition information and essential condition information between the candidate purchaser and the candidate offerer based on the acquired condition information and desired level information, and performing establishment possibility determination processing by comparing the candidate purchaser with the candidate offerer for the priority or the weighting factor assigned to the priority in the desired level information to find a matching degree, and determining the possibility that a transaction is established between both parties based on the matching degree, and a candidate list transmission procedure for collecting candidate purchasers or candidate offerers which wish for the same article in the transaction and match in the essential condition information, found from the matching processing, to create a candidate transaction partner list, associated with the result of the establishment possibility determination processing, and transmitting the candidate transaction partner list to purchaser terminals and offerer terminals of candidate purchasers and candidate offerers which are listed on the candidate transaction partner list.

In addition, a computer readable recording medium has recorded thereon the transaction intermediate service providing program.

It should be further understood by those skilled in the art that the foregoing description has been made on embodiments of the invention and that various changes and modifications may be made in the invention without departing from the spirit of the invention and the scope of the appended claims.

1. A transaction intermediate service providing method for providing an intermediate service for a candidate purchaser and a candidate offerer which make a transaction on an article and/or a service with each other, wherein a transaction is intermediated by a credit organization which holds credit information on both said candidate purchaser and said candidate offerer, said method comprising the steps, executed by a server, of:
accepting from a purchaser terminal installed at said candidate purchaser and an offerer terminal installed at said candidate offerer, condition information including attribute condition information on an article desired for a transaction, transaction condition information including a desired price and parties with which the transaction is denied, and credit condition information including a financial condition desired for a transaction partner, and desired level information including information on essentiality or priority, or a weighting factor assigned to the priority for each of conditions included in said condition information, and registering said accepted information in a database;
performing matching processing for the article attribute condition information and essential condition information between said candidate purchaser and said candidate offerer based on the acquired condition information and desired level information, and determining a transaction establishment possibility by comparing said candidate purchaser with said candidate offerer for the priority or the weighting factor assigned to the priority in the desired level information to find a matching degree, and determining the possibility that a transaction is established between both parties based on the matching degree; and
collecting candidate purchasers or candidate offerers which wish for the same article in the transaction and match in the essential condition information, found from said matching processing, to create a candidate transaction partner list, associated with the result of said establishment possibility determination processing, and transmitting the candidate transaction partner list to purchaser terminals and offerer terminals of candidate purchasers and candidate offerers which are listed on the candidate transaction partner list.

2. A transaction intermediate service providing method according to claim 1, further comprising comparing a credit condition desired to a transaction partner by the candidate purchaser or the candidate offerer with credit information on said candidate purchaser or said candidate offerer held by said credit organization in the execution of the matching processing for the credit condition information or the establishment possibility determination processing.

3. A transaction intermediate service providing method according to claim 1, further comprising extracting from said database a financial instrument which matches a financial demand which arises in the transaction in accordance with financial details of the candidate purchaser or the candidate offerer, and a transaction form, and notifying the extracted financial instrument to a purchaser terminal of the associated candidate purchaser or to an offerer terminal of the associated candidate offerer.

4. A transaction intermediate service providing method according to claim 1, wherein said condition information accepted from the purchaser terminal or the offerer terminal includes information indicative of a range, wherein said matching processing includes determining a matching result in accordance with a matching degree of said range.

5. A transaction intermediate service providing system interposed between a candidate purchaser and a candidate offerer, which make a transaction on an article and/or a service with each other, for providing an intermediate service for the candidate purchaser and the candidate offerer, wherein a transaction is intermediated by a credit organization such as a financial institution which holds credit information on both said candidate purchaser and said candidate offerer, said system comprising:
a database;
an information acquisition unit for accepting from a purchaser terminal installed at said candidate purchaser and an offerer terminal installed at said candidate offerer, condition information including attribute condition information on an article desired for a transaction, transaction condition information including a desired price and parties with which the transaction is denied, and credit condition information including a financial condition desired for a transaction partner, and desired level information including information on essentiality or priority, or a weighting factor assigned to the priority for each of conditions included in said condition information, and registering said information in said database;
an analysis and processing unit for performing matching processing for the article attribute condition information and essential condition information between said candidate purchaser and said candidate offerer based on the condition information and desired level information acquired in said database, and determining a possibility that a transaction is established between said candidate purchaser and said candidate offerer by comparing said candidate purchaser with said candidate offerer for the priority or the weighting factor assigned to the priority in the desired level information to find a matching degree; and
a collecting and transmitting unit for collecting candidate purchasers or candidate offerers which wish for the same article in the transaction and match in the essential condition information, found from said matching processing, to create a candidate transaction partner list, associated with the result of the establishment possibility determination, and transmitting the candidate transaction partner list to a party which requests for intermediation.

6. A computer-executable program for causing a computer to execute a transaction intermediate service providing method for providing an intermediate service for a candidate purchaser and a candidate offerer which make a transaction on an article and/or a service with each other, wherein a transaction is intermediated by a credit organization which holds credit information on both said candidate purchaser and said candidate offerer, said method comprising the steps of:
accepting from a purchaser terminal installed at said candidate purchaser and an offerer terminal installed at said candidate offerer, condition information including attribute condition information on an article desired for a transaction, transaction condition information including a desired price and parties with which the transaction is denied, and credit condition information including a financial condition desired for a transaction partner, and desired level information including information on essentiality or priority, or a weighting factor assigned to the priority for each of conditions included in said condition information, and registering said accepted information in a database;
performing matching processing for the article attribute condition information and essential condition information between said candidate purchaser and said candidate offerer based on the acquired condition information and desired level information, and performing establishment possibility determination processing by comparing said candidate purchaser with said candidate offerer for the priority or the weighting factor assigned to the priority in the desired level information to find a matching degree, and determining the possibility that a transaction is established between said candidate purchaser and said candidate offerer based on the matching degree; and
collecting candidate purchasers or candidate offerers which wish for the same article in the transaction and match in the essential condition information, found from said matching processing, to create a candidate transaction partner list, associated with the result of said establishment possibility determination processing, and transmitting the candidate transaction partner list to purchaser terminals and offerer terminals of candidate purchasers and candidate offerers which are listed on the candidate transaction partner list.

7. A computer readable recording medium having recorded thereon the transaction intermediate service providing program according to claim 6.

8. A server interposed between transaction requesting parties comprised of a candidate purchaser and a candidate offerer, which make a transaction on a transaction object including an article and/or a service with each other, for providing a transaction intermediate service to a terminal of a transaction requesting party, said server being installed in a credit organization including a financial institution which holds credit information related to each of transaction requesting parties, and interconnected to transaction terminals through a network, said server comprising:
a database for holding said credit information;
information acquiring means for registering transaction condition information related to a transaction object of a transaction requester, condition level information indicative of a required level for conditions associated with said information, and a credit condition required to a transaction partner in said database;
means for matching attributes of the transaction object and predominant condition information between requesting parties to find a matching degree, determining the level of a possibility that a transaction is established between said transaction requesting parties in accordance with the matching degree, and generating a candidate transaction partner list in accordance with the level of the possibility; and
means for providing said list to said transaction requesting parties,
said list generating means performing the matching processing by comparing the credit condition required to a transaction partner by the transaction requesting party with credit information on the transaction partner held by said credit organization.
